(19) United States
(12) Patent Application Publication
(10) Pub. No.: US 2025/0052724 A1
(43) Pub. Date: Feb. 13, 2025

(54) IMPROVEMENTS IN AND RELATING TO ULTRASOUND PROBES

(71) Applicant: CAVENDISH NUCLEAR LIMITED, Birchwood (GB)

(72) Inventors: Randika Kosala Wathavana VITHANAGE, Glasgow (GB); Charles Norman MACLEOD, Glasgow (GB); David Ian Arthur LINES, Glasgow (GB)

(21) Appl. No.: 18/721,657

(22) PCT Filed: Dec. 22, 2022
(86) PCT No.: PCT/GB2022/053360

§ 371 Date: Jun. 18, 2024

(30) Foreign Application Priority Data
Dec. 22, 2021 (GB) 2118780.2

(51) Int. Cl. G01N 29/24; G01N 29/22; G01N 29/265

(52) U.S. Cl. CPC G01N 29/2493; G01N 29/228; G01N 29/265; G01N 2291/044; G01N 2291/267

(57) ABSTRACT

An ultrasound probe and method of use are provided, wherein an ultrasound emitting transducer is mounted on an axial element which is supported in a rotatable configuration. A compliant element, such as a high temperature silicone rubber, provides a contact surface for the welding locations being probed and defines the outside of a space to which coolant is provided. The coolant ensures optimum operating conditions for the transducer, even when used to probing welding locations which are still at high temperatures, for instance in excess of 350° C. A probe which can be used closer to and sooner after welding has occurred results.

This disclosure concerns improvements in and relating to ultrasound probes, coupling devices therefor and methods of use thereof, in non-destructive ultrasound testing, particularly but not exclusively in relation to high temperature deployments thereof.

Ultrasonic testing is used for the non-destructive testing of a wide variety of objects. A transmitting transducer emits ultrasound waves which enter the object, interact with the object and sub-features thereof, and then return to a receiving transducer. Effective transmission of the ultrasound into the object is important, to avoid high levels of reflection at the interface. A liquid coupler is often used to improve transmission at the interface.

When testing welds, after completion of the weld or after each individual weld pass, it is desirable to be able to conduct the ultrasound test soon after the weld or weld pas has been formed, so as to minimise the time take to perform, test and then make any corrections needed to the weld or weld pass. However, liquid couplers such as water, have clear limits on the temperatures of object that they can operate on and so the object piece has to cool to a material extent before testing in such cases. If correction is needed, or further weld passes then the object then has to be brought up to temperature again.

EP1448983 provides an example of a wheel or roller probe in which an array of transducers emit the ultrasound waves into a liquid filled cavity and hence via a coupling element into the object to be tested. The probe therefore has a substantial water path length between the transducer and the coupling element. The liquid filled cavity is sealed and so the same liquid is present therein during the operation of the probe. A rigid annular element is provided at each end, with the compliant coupling element present between the rings and partially clamped between them. The annular elements control the position of the probe and hence the force applied to deform the coupling element to attempt a dry coupling to the object.

Amongst the potential aims of the disclosure is to provide an ultrasound probe that can operate on higher temperature surfaces for longer periods of time. Amongst the potential aims of the disclosure is to provide improved probe to substrate contact, particularly in high temperature contexts.

According to a first aspect of the disclosure there is provided an ultrasound probe comprising: an axial element;
an ultrasound emitting transducer mounted on the axial element;
two or more support elements rotatable mounted relative to the axial element;
a compliant element, the compliant element being mounted on the two or more support elements and providing a continuous surface in at least one direction;
wherein the two or more support elements and the compliant element at least partially define an internal volume for the probe, the transducer being provided within the internal volume; the probe further comprising an inlet for coolant to the internal volume and an outlet for coolant from the internal volume.

The axial element may extend from one side of the probe to the other side. The axial element may include one or more mounting locations for the probe, for instance for mounting on a multi-axis robotic arm. The axial element may have a greater axial length that the length of the compliant element in or parallel to that direction.

The ultrasound emitting transducer may be a phased array. The transducer may be a 5 MHz 64 element phased array. The transducer may be mounted at an angle relative to the axis, for instance to provide ultrasound at an angle of 55° relative to the substrate [+/−20°]. The transducer may provide a sectorial scan beam defined by the upper extremity beam [for instance angled at −ve steer angles with respect to the transducer face] and the lower extremity beam [near perpendicular to the transducer face] emitted.

The axial element may provide a first mounting location lying on an axis, together with a second mounting location lying on the same axis

The support elements may include one or more end structures, for instance rigid end structures. One or more end structures may be provided at each end of the probe. One or more or all of the end structures may extend radially away from the axis.

Two spaced end structures may provide a mounting location between them for at least a part, for instance an annular part, of the compliant element. Such a mounting location may be provided at one or both ends of the probe.

The compliant element may provide the outside side surface of a generally cylindrical profile. The one or more end structures may provide the end surfaces of the generally cylindrical profile. The cylindrical profile may have a greater radial extent at one or more intermediate locations compared with one or more end locations. The compliant element may have a greater radial extent that one or more or all of the end structures.

The compliant element may be a higher temperature compatible silicone rubber. The material of the compliant element may be able to withstand temperatures in excess of 250° C., for instance in excess of 300° C., or even in excess of 350° C. The material of the compliant element may be able to withstand the temperature for at least 5 mins, for instance at least 10 mins or even at least 15 mins, potentially at least 20 mins.

The compliant element may be able to withstand the temperature and/or time of contact, in terms of retaining at least 90%, possibly at least 95%, for instance at least 99%, of the acoustic performance and/or the thermal performance of the compliant element material compared with the performance before contact.

The compliant element may be formed of or include one or more rubbers, for instance one or more high temperature silicone rubbers.

The compliant element may have a thickness balancing the acoustic performance and the thermal performance of the compliant element material. The compliant element may have a thickness of greater than 2 mm, for instance greater than 3 mm, potentially between 2 mm and 10 mm, for instance between 4 mm and 8 mm.

The compliant material may offer sufficient compliance for it to conform to the surface of the substrate under moderate applied force levels.

The internal volume may be fluid tight relative to the environment around the probe.

The internal volume may include the transducer and/or an ultrasound conveying block and/or a temperature sensor such as a thermistor and/or one or more blocks deleterious to the internal reflections of ultrasound waves.

The internal volume may be at least 60% filled with coolant, in use. The internal volume may be at least 75% filled with coolant, in use. The internal volume may be at less than 90% filled with coolant, in use. The internal volume may be at less than 80% filled with coolant, in use.

The internal volume may be at least 98% filled, preferably 100% filled, particularly for applications requiring inversion of the probe.

The internal volume may not be pressurised, for instance at 1 atmosphere.

One or more or all of the transducer and/or an ultrasound conveying block and/or a temperature sensor such as a thermistor and/or one or more blocks deleterious to the transmission and/or reflection of ultrasound waves may be surrounded by coolant, in use.

At least a part of the coolant inlet may be aligned along or parallel with an axis of rotation for the probe. At least a part of the coolant outlet may align along or parallel with an axis of rotation for the probe. At least a part of the coolant inlet and the coolant outlet may be coaxial with one another, for instance with the outlet within the inlet.

At least a part of the coolant inlet may be directed toward an interface between the transducer and an ultrasound conveying block. The at least a part of the coolant inlet may have an axis and a projection of that axis may intersect with a part of the interface.

An end of the coolant inlet may reach the internal volume closer to the middle of the internal volume than the start of the coolant outlet leading away from the internal volume. The end of the coolant inlet may be in the middle 40% of the internal volume. The start of the outlet may be provided in the end 10% of the internal volume.

The probe may include an ultrasound conveying block provided between the transducer and the compliant element, the compliant element being rotatable relative to the ultrasound conveying block.

One or more passageways, such as coolant conveying passageways, may be provided in the conveying block. One or more passageways may be provided in the conveying block providing a fluid communication between the coolant inlet and the internal volume of the probe. One or more passageways may be provided in the conveying block providing a fluid communication between the internal volume of the probe and the coolant outlet. One or more of the passageways may be non-linear, for instance serpentine.

The probe may include an ultrasound conveying block extending between the transducer and the compliant element, a fluid flow route being provided between at least a part of the ultrasound conveying block and at least a part of an opposing section of the transducer. The fluid flow route may extend across at least 70%, for instance at least 80%, optionally at least 90% and for instance 100% of the surface of the ultrasound block facing the transducer and/or of the surface of the transducer facing the ultrasound conveying block.

The probe may include an interface, potentially including a fluid flow route, provided between at least a part of the ultrasound conveying block and at least a part of an opposing section of the transducer.

One or more channels, for instance for coolant, may be provided outside or and/or adjacent to the interface. A channel may be provided extending across the conveying block, for instance outside of and/or adjacent to the interface. The channel may extend from one side of the conveying block to the other side of the conveying block. The channel may be provided at the start of the interface, for instance relative to the direction of movement and/or rotation.

One or more further channels, for instance for coolant, may be provided. At least three further channels may be provided. One or more further channels may be provided extending from outside or and/or adjacent to the interface to within the interface. One or more further channels may be provided extending along the conveying block and/or extending along and/or across the interface. One or more further channels may extend from the one or more channels, for instance generally perpendicular to the one or more channels.

The probe may include a surface of an ultrasound conveying block faces the transducer and a surface of the transducer faces the surface of the ultrasound conveying block, wherein the separation of the two surfaces is greater at one or more peripheral parts of those faces than at one or more central parts of those faces. The probe may include a surface of an ultrasound conveying block faces the transducer and wherein at least a part of the perimeter of the face is spaced further from a surface of the transducer than one or more non-perimeter parts.

The probe may include an ultrasound conveying block extends between the transducer and the compliant element, a fluid flow route being provided between at least a part of the ultrasound conveying block and at least a part of an opposing section of the compliant element. The fluid flow route may extend across at least 70%, for instance at least 80%, optionally at least 90% and for instance 100% of the surface of the ultrasound block facing the compliant element and/or of the surface of the compliant element facing the ultrasound conveying block.

The probe may include a surface of an ultrasound conveying block faces the compliant element and a surface of the compliant element faces the surface of the ultrasound conveying block, wherein the separation of the two surfaces is greater at one or more peripheral parts of those faces than at one or more central parts of those faces. The probe may include a surface of the ultrasound conveying block faces the compliant element and wherein at least a part of the perimeter of the face is spaced further from a surface of the compliant element than one or more non-perimeter parts.

The probe may provide that a distance is defined between the transducer and a section of the compliant element opposing the transducer, and wherein less than 5% of that distance is occupied by fluid. Less than 3% of that distance may be occupied by fluid.

The probe may provide that one or more sections of the ultrasound conveying block apply a force to one or more opposing sections of the compliant element. The probe may provide that the force is at least in part transmitted by a coolant fluid from one or more sections of the ultrasound conveying block to one or more opposing sections of the compliant element.

The probe may include one or more blocks deleterious to the transmission and/or reflection of ultrasound waves. One or more blocks deleterious to the transmission and/or reflection of ultrasound waves may be provided adjacent or in contact with one or more surfaces of the ultrasound conveying block, for instance to one or both axial sides thereof.

The first aspect of the disclosure may include any of the features or possibilities or options set out elsewhere in the document, including in the other aspects of the disclosure.

According to a second aspect of the invention there is provided a method of performing an ultrasound based investigation of a substrate, the method including:
providing an ultrasound probe comprising:
an axial element;
an ultrasound emitting transducer mounted on the axial element;
two or more support elements rotatable mounted relative to the axial element;
a compliant element, the compliant element being mounted on the two or more support elements and providing a continuous surface in at least one direction;
   wherein the two or more support elements and the compliant element at least partially define an internal volume for the probe, the transducer being provided within the internal volume; the probe further comprising an inlet for coolant to the internal volume and an outlet for coolant from the internal volume;
   the method further providing:
   placing at least a section of the compliant element in contact with the substrate;
   passing ultrasound from the transducer into the substrate and detecting ultrasound returns from the substrate;
   wherein coolant is fed into the internal volume via the coolant inlet and coolant is removed from the internal volume during the passing of ultrasound.

The method may provide that the temperature of the substrate at the location contacted by the section of the compliant element has a temperature of at least 250° C. The method may provide that the temperature of the substrate at the location contacted by the section of the compliant element has a temperature of at least 300° C.

The method may include the probe being rolled across the substrate, for instance, such that different sections of the compliant element contact the substrate at different locations on the substrate.

The method may include pumping the coolant into and/or out of the probe.

The method may include cooling the coolant outside of the probe. The method may include cooling the coolant using a heat exchanger.

The method may include returning coolant to the internal volume multiple times.

The second aspect of the disclosure may include any of the features or possibilities or options set out elsewhere in the document, including in the other aspects of the disclosure.

Various embodiments of the disclosure will now be described, by way of example only, and with reference to the accompanying drawings, in which:

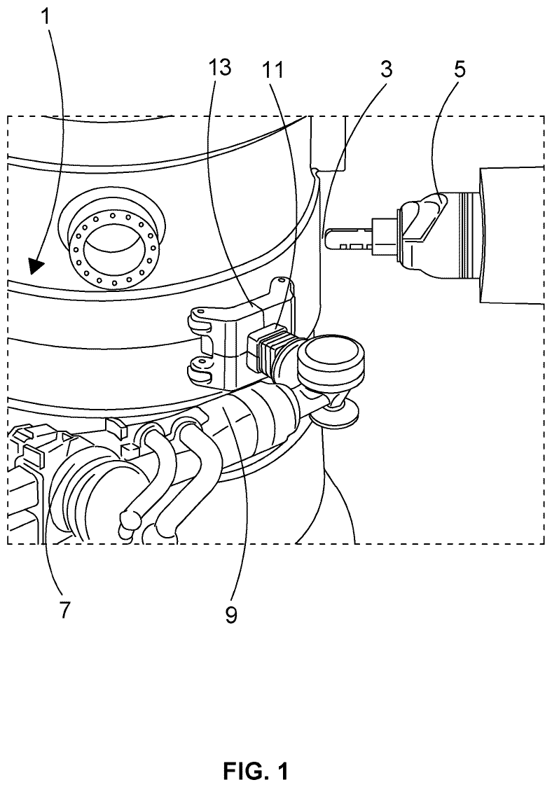

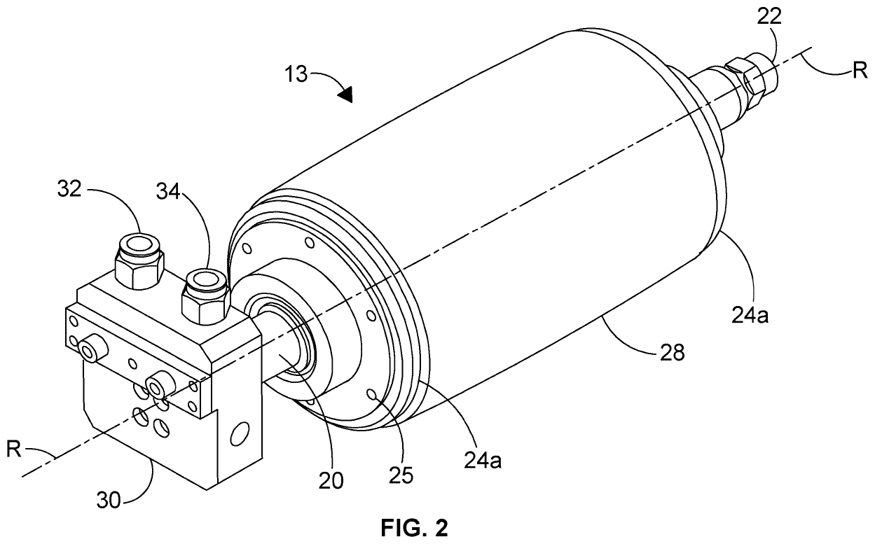

FIG. 1 is a perspective view of a desired environment of use for the probes of the disclosure;

FIG. 2 is a perspective view of a probe according to a first embodiment of the disclosure;

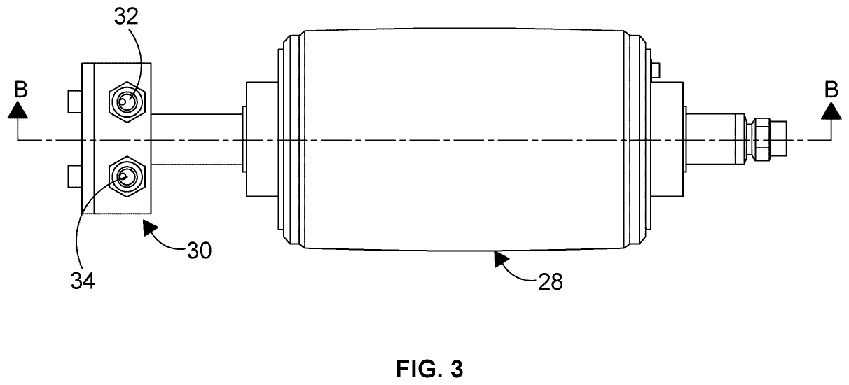

FIG. 3 is a plan view of the probe of FIG. 2;

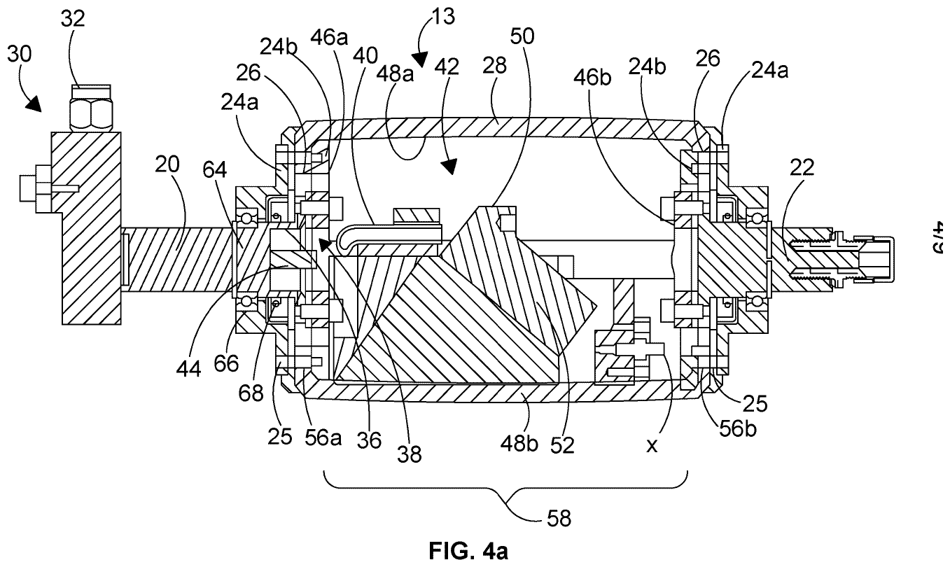

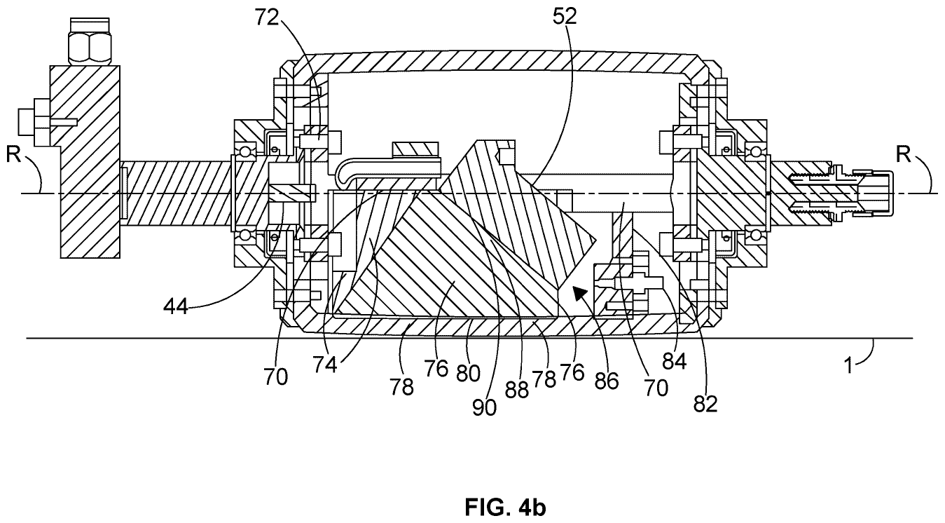

FIG. 4a is a cross-sectional side view of the probe of FIG. 3 on plane B-B;

FIG. 4b is the same view as FIG. 4a, but illustrating further features;

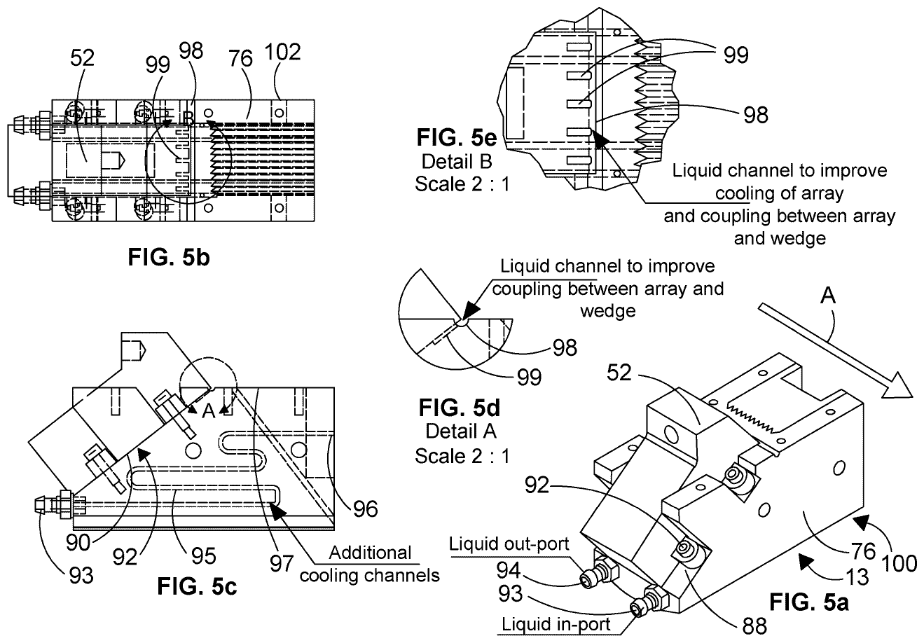

FIG. 5a is perspective view of a probe and conveying block;

FIG. 5b is a top plan view of the probe and conveying clock of FIG. 5a;

FIG. 5c is a side view of the probe and conveying block of FIG. 5a;

FIG. 5d is a side view detail of the top part of the interface between the probe and the conveying block;

FIG. 5e is a top plan detail of the same location as FIG. 5d;

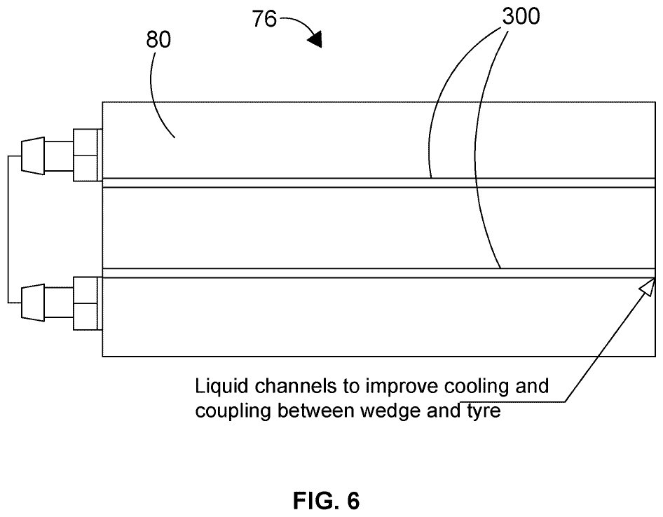

FIG. 6 is a view of the lower surface of the conveying block which faces the compliant element;

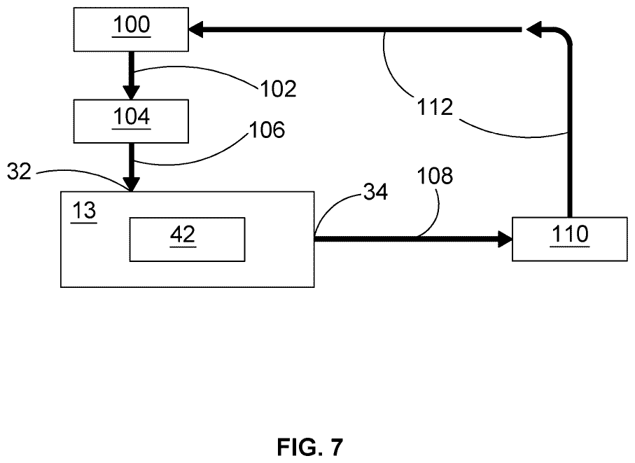

FIG. 7 is a schematic of a cooling circuit for use with a probe according to the disclosure;

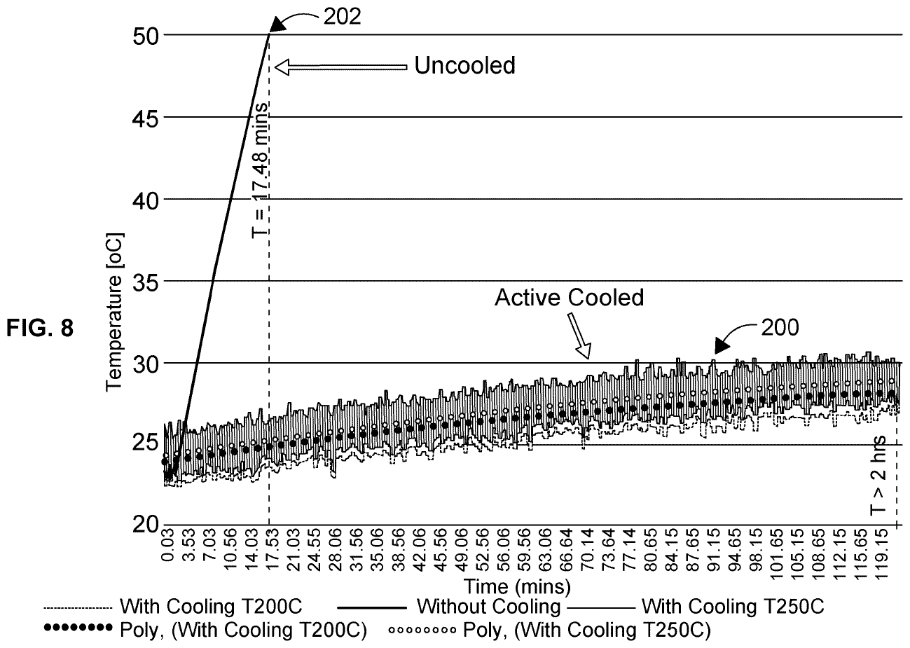

FIG. 8 is a temperature plot of an active cooled probe according to the disclosure compared with a fixed coolant volume probe.

Ultrasonic testing is used for the non-destructive testing of a wide variety of test pieces. A transmitting transducer emits ultrasound waves which enter the test piece, interact with the test piece and sub-features thereof, and then return to a receiving transducer. Effective transmission of the ultrasound into the test piece is important, to avoid high levels of reflection at the interface. A liquid coupler is often used to improve transmission at the interface.

When testing welds, after completion of the weld, it is desirable to be able to conduct the ultrasound test soon after the weld has been formed, so as to minimise the time take to perform, test and then make any corrections needed to the weld. However, liquid couplers, such as water, have clear limits on the temperatures of test piece that they can operate on and so the test piece has to cool to or near to ambient before testing in such cases.

The ability for an ultrasound probe to operate successfully at higher temperatures would mean that probe could be used closer to the welding location, in time and in distance. This would include between individual weld passes. This in turn would reduce the time delay between the weld being formed at a location and the detection of any issue with the weld at that location.

This improvement could facilitate faster inspection to detect imperfections and flaws at the point of generation and thus enable remedial work to be commenced sooner. For instance, the flaw could be detected without having to complete all of the passes and without having to wait for the object to cool. Any flaw could be corrected faster as there is less delay than in getting the object down to measurement temperature and then back up to welding temperature afterwards. These steps increase throughput, minimising risk and reduce costs.

Allowing the object to cool between weld passes for inspection purposes is undesirable as repeated heat, cool, heat, cool cycles can affect the microstructure of the object in undesirable ways.

This improvement could also facilitate more closed loop control and automation to minimise the generation of imperfections and flaws within the welded component. By monitoring the conditions and adapting the control of welding equipment, the system can ensure optimum conditions are maintained.

To allow higher temperature working, there are two main challenges to address: successful acoustically coupling the probe to the test piece through the real-world surface encountered; and withstanding the elevated surface temperatures of the test piece.

FIG. 1 shows an object 1 being welded at welding location 3 by a welding device 5. A multiple axis robot 7 is also provided with an arm 9 on the distal end 11 of which is a schematically illustrated probe 13. The probe 13 is in contact with a testing location 15 which was recently the welding location.

FIG. 2 is a perspective view of an embodiment of a probe 13. The axis of rotation R-R extends through the probe 13. A first mounting location 20 is provided lying on the axis, together with a second mounting location 22 on the other side of the probe 13. The first mounting location 20 and the second mounting location 22 provide for the mounting of the probe 13 on the robot 7 in a manner which allows for rotation of the probe 13 as it is advanced over the surface of the object 1.

The probe 13 has rigid end structures 24a, 24b at each end and these are provided with bolts 25 to connect them and to provide an annular mounting 26 for the generally cylindrical coupling element 28.

Connected to the first mounting location 20 and extending axially therefrom, is a manifold element 30. The manifold element 30 has a cooling fluid inlet 32, which is connected in use to a cooling fluid feed conduit [not shown], and a cooling fluid outlet 34, which is connected in use to a cooling fluid exit conduit [also not shown].

FIG. 3 is a cross-sectional plan view of the probe of FIG. 2 also showing many of the above features.

Referring to FIG. 4a, a cross-sectional side view of the probe of FIG. 2, the manifold element 30 is fluidly connected to the first mounting location 20. A first fluid connection is formed by first inlet bore section 36 connecting to second inlet bore section 38 which leads via a conduit 40 to the internal volume 42 of the probe 13. A second fluid connection is formed by first outlet bore section 44 connecting to a second outlet bore section [not shown] which leads from the internal volume 42 of the probe 13.

The internal volume 42 extends between the opposing wall sections 46a, 46b of the coupling element 28 and also extends between the opposing internal surfaces 48a, 48b of the rigid end structures 24a, 24b. The internal volume 42, at least to a level above the maximum vertical extent 50 of the transducer 52, is filled with a coolant.

The coupling element 28 is a unitary piece of compliant material, discussed further below. The coupling element 28 is provided with generally right cylindrical main body part 54 and with an inwardly turned rim 56a, 56b at the ends. The rims 56a, 56b are each compressed between an external element 24a and an internal element 24b which form the rigid end structure 24a. The external element 24a and opposing internal element 24b are connected to one another by a series of releasable fasteners, in this case bolts 25.

Thus, as the probe 13 rolls over the surface of the object, different parts of the main body part 54 of the coupling element 28 contact the object and the external element 24a and an internal element 24b which form the rigid end structure rotate too.

The rigid end structure 24a, 24b is free to rotate relative to axial element 64, a continuation of which provides the first mounting location 20. A first shaft type seal 66 and a second shaft type seal 68 allow for the rotation whilst sealing against coolant leakage between the axial element 64 and the rigid end structure 24.

A second axial element 70 is connected to the axial element 64 by a series of releasable fasteners 72. The second axial element 70 provides a mounting for the transducer 52, for an anti-echo block 74 and a ultrasound conveying block 76.

Thus, the transducer 52, anti-echo block 74 and conveying block 76, together with the second axial element 70, the axial element 64 and the first mounting location 20 do not rotate as the probe 13 rolls over the surface of the object. Thus, the transducer 70 and associated components are maintained in the same sensing orientation opposing the object, at all times.

As a result of the abovementioned configuration, when the probe 13 rolls over the surface of the object, there is relative movement between the inside surface 78 of the coupling element 28 and the radial surface 80 of the conveying block 76.

Also mounted on the second axial element 70 is a mounting element 82 that carries a thermistor 84 for temperature sensing of the internal roller probe domain at a location 86 close to the part of the inside surface 78 that abuts the welded location.

As seen in FIG. 5a to 5e, alternative embodiments of the probe 13, transducer 52 and conveying block 76 can be provided. As shown in FIG. 5a, the transducer 52 is mounted on an inclined, axial facing surface 88 of the conveying block 76 by means of fasteners 92. The conveying block 76 is provided with a coolant inlet 93 and a coolant outlet 94. As seen in FIG. 5c, the coolant inlet 93 leads to a serpentine passageway 95 and hence to a coolant feed outlet 96 in fluid communication with the internal volume 42 of the probe 13. A similar structure on the other side of the conveying block 76 extracts coolant from the internal volume, through a coolant withdrawal inlet, to a second serpentine passageway and hence to the coolant outlet 94. These passageways and the configuration of these passageways assists with the cooling of the conveying block 76.

The axial facing surface 88 of the conveying block 76 and/or the radial facing surface 90 of the transducer 52 can be provided with gaps, slots or grooves to aid coolant flow between the two surfaces.

For instance, referring to FIGS. 5c and 5d, the inclined, axial facing surface 88 has an intersection with a second axial facing surface 97, which face 97 is generally parallel to the axis of rotation. The transducer 52 ends close to the intersection. As seen in the detail of FIG. 5d, a channel 98, such as a groove, is provided in the conveying block 76. The channel 98 improves access for coolant to the gap 92 between the axial facing surface 88 of the conveying block 76 and the radial facing surface 90 of the transducer 52. The channel 98 is in fluid communication with a series further grooves 99 in the axial facing surface 88 of the conveying block 76 to further promote coolant flow into the gap 92. The channel 98 and/or further channels 99 could be provided in the transducer 52 and/or in the conveying block 76.

As seen in FIG. 5b and the detailed view of FIG. 5e, the channel 98 extends across the width of the conveying block 76 from one side to the other. The further channels 99 are regularly spaced along the channel 98 and extend along the inclined, axial facing surface 88 away from the channel 98.

In another potential detail, the leading edge 100 and the trailing edge 102, considered relative to the rotation when the probe 13 moves in direction A, of the conveying block 76 are each provided with a chamfer. Thus, as the conveying block 76 effectively moves through the coolant during rotation, the coolant is encouraged by the chamfer on the leading edge 100 towards the gap 108 between the radial facing surface 80 of the conveying block 76 and the inside surface 78 of the coupling element 28. This encourages the continuous presence of the coolant between the radial surface 80 and the inside surface 78, which is very beneficial for the passage of the ultrasound waves across the interface between the conveying block 76 and the coupling element 28. The continuous presence of the coolant is also helpful with cooling of the radial surface 80 too.

The separation of the axis of rotation R-R and the object 1 being probed is such, in use, that the object 1 pushes the coupling element 28 towards the axis and so into good contact with the conveying block 76, with the coupling element 28 being compressed between the object 1 and the conveying block 76.

As can be seen in FIG. 5a, in another potential detail, the axial facing surface 88 of the conveying block 76 has a greater extent along the axis and perpendicular to the axis that the radial facing surface 90 of the transducer 52. As the conveying block 76 and transducer 52 are moved through the coolant by rotation of the probe 13, this geometry encourages coolant into the junction between the conveying block 76 and the transducer 52 and so into the gap 92 therebetween. The flow direction of the coolant into the device along conduit 42 also promotes flow in the direction of the gap 92.

In a still further potential detail, shown in FIG. 6, the radial facing surface 80 of the conveying block 76 is provided with a series of interface channels 300. These are recessed into the curved radial facing surface 80 which faces the inside surface 78 of the coupling element 28 in use. The interface channels 300 extend the full length of the conveying block 76 and extend parallel to the axis, but other extents and profiles can be provided.

The continuous presence of the coolant in the gap 92 between the axial facing surface 88 of the conveying block 76 and the radial facing surface 90 of the transducer 52 is very beneficial for the passage of the ultrasound waves across the interface between them.

With respect to the passage of ultrasound waves, the conveying block 76 is fabricated from polyetherimide, as that offers the desired temperature resistance and capacity to deal with repeated cycles of temperature changes. Furthermore, the material has the necessary acoustic properties to be balanced with the other components.

For monitoring purposes, the thermistor 84 is provided within a further block of polyetherimide, offset to the side of the conveying block 76, so as not to interfere with the conveying block 76 ultrasound propagation role. At the same time, the position of the thermistor 84 is still effective in insuring that the temperature constraints of the components are not approached. If they are, then the probe 13 can be removed from the object to prevent damage of the components. The block providing the thermistor 84 may be attached to the conveying block 76 in other embodiments, and the thermistor 84 could be incorporated into the conveying block 76 in other embodiments.

With respect to the passage of ultrasound waves, the coupling element 28 is a higher temperature compatible silicone rubber. The material selected is able to withstand temperatures in excess of 350° C. for prolonged periods. Such materials can have an attenuation of 0.87 dB/mm at 5 Mhz and an acoustic impedance of 1.12 MRayls and so is a good alignment with the other materials employed.

In terms of the thickness of the coupling element 28, a balance is struck between increasing thickness giving more thermal insulation to the probe contents and increasing thickness causing detrimental increases in attenuation. A thickness of between 4 mm and 8 mm is suitable for such materials in the operating conditions under consideration.

The chosen materials for the coupling element 28 also offer sufficient compliance for it to conform to the surface of the object under moderate applied force levels. High force levels are undesirable in terms of the equipment needed to generate them and still move the device over the test piece. A compliant material is needed to gain good contact for the transmission of the ultrasound, without undue loss, given that the surfaces of the objects encountered in real world situations are not highly finished or smooth.

With respect to the passage of ultrasound waves, the anti-echo block 74 has an important role in preventing ultrasound waves bouncing within the probe and causing noise or other negative impacts upon the probe. Hydrogenated nitrile rubber, HNBR, was found to be a suitable material, particularly N filler forms thereof. This was due to the 6.4 dB/mm attenuation provided at 5 MHz.

All of these features serve to assist with successful acoustically coupling of the probe to the object through the real-world surface encountered.

To assist with the withstanding of the elevated surface temperatures of the object, the coolant circuit for the probe 13 is used.

FIG. 7 shows a schematic for the coolant circuit in one embodiment thereof. A coolant reservoir 100 provides a coolant feed through conduit 102 to pump 104 and second conduit 106 to the cooling fluid inlet 32 provided on the probe 13.

Within the internal volume 42, the coolant is able to freely circulate within the full volume of that internal volume, including around the transducer 52, around the conveying block 76, through the gap therebetween, around the lower parts at least of the coupling element 28 and through the gap 92 between the coupling element 28 and the radial facing surface 80 of the conveying block 76.

Returning to FIG. 7, from the internal volume 42, the coolant exists through cooling fluid outlet 34 and into a third conduit 108. A temperature sensor in the third conduit and/or within the internal volume 40 can be used to ensure cooling is as desired and potentially to control the pump speed to increase or decrease cooling. The third conduit 108 leads to a heat exchanger 110 which provides cooling of the coolant ready for reuse. The fourth conduit 112 takes the cooled coolant from the heat exchanger 110 and returns it to the reservoir 100 ready for reuse.

The use of active cooling for the probe 13 and its elements is beneficial in allowing the probe 13 to be used on hot object surfaces for prolonged periods of time.

Referring to FIG. 8, this shows a first temperature plot 200 and a second temperature plot 202, both against time that the probe in contact with the hot object. The first temperature plot 200 is for a probe 13 according to the disclosure and with circulating coolant. This shows that the approach is successful in maintaining the internal temperature of the probe 13 well within operating limits. The active cooling provides ensures that the transducer is kept below the 55 to 60° C. maximum operating temperatures applicable to most transducers of the desired type.

The second temperature plot 202 is for a probe with similar internal components, but with the coolant volume fixed and limited to that sealed within the internal volume of the probe. The temperature clearly rises with time as heat transfers to the probe and builds up therein, until after a relatively short period of time, the temperature exceeds a reliable operating threshold of 50° C. In practice, such a probe would have to be removed from the object before that threshold of 50° C. was reached and no monitoring could occur until the probe itself had cooled down.

In terms of the coolant, air offers poor thermal capacity and conductivity for active cooling. Water is also a sub-optimal as its acoustic impedance at at 1.5 MRayls is a poor match for the other components. Providing the coolant, in the form of a water-soluble oil, for instance which has an acoustic impedance of 1.1 MRayls and so is a better match with the acoustic impedance of the conveying block [1.1 or so MRayls].

The transducer 52 provides a 5 Mhz 64 element phased array and is mounted to generate 55° ultrasound waves into the object. A 0.5 mm pitch and 10 mm elevation can be used. An angled beam is beneficial in being able to inspect the weld fully from a laterally spaced location. Frequently, that laterally spaced location will be more amenable to good contact between the probe and the object, that at the location where welding is occurring. For instance, in multi-pass welds, until the weld is completed, there will be a significant depression which will interfere with good contact and ultrasound propagation into the object. This is an issue with 0° or low angle-based approaches.

This type of transducer and conveying block configuration can be used to provide a sectorial scan beam defined by the upper extremity beam [angled away from the perpendicular to the transducer face] and the lower extremity beam [near perpendicular to the transducer face] emitted.

In terms of the performance sought for the probe in terms of high temperature performance, the disclosure provides probes that are capable of inspecting for prolonged period objects that are at 300° C.

The coupling is dry but still achieves the necessary levels of ultrasound propagation through the interface into and back from the object.

The high-temperature polymer used in the coupling component is able to withstand prolonged contact with objects at such temperatures and still propagate the ultrasound to and from the interface successfully.

The coolant and hence the coolant filled gaps are able also to effectively propagate the ultrasound waves to and from the conveying block.

Optimal propagation properties for the conveying block are provided as the block is exposed to near ambient temperatures only and so there is no need to choose high temperature resistant materials which have lesser ultrasound propagation properties.

1. An ultrasound probe comprising:
an axial element;
an ultrasound emitting transducer mounted on the axial element;
two or more support elements rotatable mounted relative to the axial element;
a compliant element, the compliant element being mounted on the two or more support elements and providing a continuous surface in at least one direction;
wherein the two or more support elements and the compliant element at least partially define an internal volume for the probe, the transducer being provided within the internal volume;
the probe further comprising an inlet for coolant to the internal volume and an outlet for coolant from the internal volume.

2. A probe according to claim 1, wherein at least a part of the coolant inlet is aligned along or parallel with an axis of rotation for the probe.

3. A probe according to claim 1, wherein at least a part of the coolant outlet is aligned along or parallel with an axis of rotation for the probe.

4. A probe according to claim 1, wherein at least a part of the coolant inlet and the coolant outlet are coaxial with one another.

5. A probe according to claim 1, wherein at least a part of the coolant inlet is directed toward an interface between the transducer and an ultrasound conveying block.

6. A probe according to claim 1, wherein the end of the coolant inlet reaches the internal volume closer to the middle of the internal volume than the start of the coolant outlet leading away from the internal volume.

7. A probe according to claim 1, wherein an ultrasound conveying block is provided between the transducer and the compliant element, the compliant element being rotatable relative to the ultrasound conveying block.

8. A probe according to claim 1, wherein an ultrasound conveying block extends between the transducer and the compliant element, a fluid flow route being provided between at least a part of the ultrasound conveying block and at least a part of an opposing section of the transducer.

9. A probe according to claim 1, wherein a surface of an ultrasound conveying block faces the transducer and a surface of the transducer faces the surface of the ultrasound conveying block, wherein the separation of the two surfaces is greater at one or more peripheral parts of those faces than at one or more central parts of those faces.

10. A probe according to claim 1, wherein a surface of an ultrasound conveying block faces the transducer and wherein at least a part of the perimeter of the face is spaced further from a surface of the transducer than one or more non-perimeter parts.

11. A probe according to claim 1, wherein an ultrasound conveying block extends between the transducer and the compliant element, a fluid flow route being provided between at least a part of the ultrasound conveying block and at least a part of an opposing section of the compliant element.

12. A probe according to claim 1, wherein a surface of an ultrasound conveying block faces the compliant element and a surface of the compliant element faces the surface of the ultrasound conveying block, wherein the separation of the two surfaces is greater at one or more peripheral parts of those faces than at one or more central parts of those faces.

13. A probe according to claim 1, wherein a surface of the ultrasound conveying block faces the compliant element and wherein at least a part of the perimeter of the face is spaced further from a surface of the compliant element than one or more non-perimeter parts.

14. A probe according to claim 1, wherein a distance is defined between the transducer and a section of the compliant element opposing the transducer, and wherein less than 5% of that distance is occupied by fluid.

15. A probe according to claim 1, wherein one or more sections of the ultrasound conveying block apply a force to one or more opposing sections of the compliant element.

16. A probe according to claim 15, wherein the force is at least in part transmitted by a coolant fluid from one or more sections of the ultrasound conveying block to one or more opposing sections of the compliant element.

17. A probe according to claim 1, wherein the internal volume is at least partially filled with coolant and wherein the coolant is a liquid.

18. A probe according to claim 17, wherein the coolant surrounds the transducer.

19. A probe according to claim 1, wherein the coolant liquid is oil.

20. A method of performing an ultrasound based investigation of a substrate, the method including:
providing an ultrasound probe comprising:
an axial element;
an ultrasound emitting transducer mounted on the axial element;
two or more support elements rotatable mounted relative to the axial element;
a compliant element, the compliant element being mounted on the two or more support elements and providing a continuous surface in at least one direction;
wherein the two or more support elements and the compliant element at least partially define an internal volume for the probe, the transducer being provided within the internal volume;
the probe further comprising an inlet for coolant to the internal volume and an outlet for coolant from the internal volume;
the method further providing:
placing at least a section of the compliant element in contact with the substrate;
passing ultrasound from the transducer into the substrate and detecting ultrasound returns from the substrate;
wherein coolant is fed into the internal volume via the coolant inlet and coolant is removed from the internal volume during the passing of ultrasound.

21. A method according to claim 20, wherein the temperature of the substrate at the location contacted by the section of the compliant element has a temperature of at least 250° C.

22. A method according to claim 20, wherein the temperature of the substrate at the location contacted by the section of the compliant element has a temperature of at least 300° C.

23. A method according to claim 20, wherein the probe is rolled across the substrate such that different sections of the compliant element contact the substrate at different locations on the substrate.
